(19) United States
(12) Patent Application Publication
(10) Pub. No.: US 2009/0094659 A1
(43) Pub. Date: Apr. 9, 2009

(54) Identification of Streaming Content and Estimation of Playback Location Based on Closed Captioning

(75) Inventor: Brant Candelore, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS, INC., Park Ridge, NJ (US)

(21) Appl. No.: 11/868,430

(22) Filed: Oct. 5, 2007

(51) Int. Cl. H04N 7/173

(52) U.S. Cl. 725/131

(57) ABSTRACT

Apparatus for identifying an audiovisual content stream received from an audiovisual content source includes an audiovisual content display that displays the audiovisual content stream to a user. A closed captioning receiver receives a first plurality of consecutive closed captions from the audiovisual content stream substantially at a playback position. A comparator identifies the audiovisual content stream by matching the first plurality of closed captions to a database having a second plurality of closed captions. The database includes an identification of audiovisual content for each of the second plurality of closed captions. A presentation unit presents additional information related to the identification of the audiovisual content to the user. The database may include a playback location in the audiovisual content for each of the second plurality of closed captions, the comparator may estimate the playback position, and additional information related to the estimated playback position may be presented to the user.

### BACKGROUND

Audiovisual content streams may be received from a variety of devices for display or storage by various types of audiovisual content display apparatus. It may be desirable to display information about or related to the received audiovisual content stream. However, the display device may receive the audiovisual content stream as compressed or decompressed content without any metadata that provides information about the content such as its identity (title) or the playback position within the content.

An example of such content delivery would be the delivery of content to a television monitor by a cable set top box. The cable set top box may provide the audiovisual content stream to the television monitor via an analog or digital signal connection that provides for the delivery of content but not associated identifying data. As the cable set top box may handle interaction with the viewer to select the content, the television monitor may be completely deprived of any information about the content being displayed.

Even if the television monitor does have the title of the audiovisual content, it may not have any information about the location of where in the content playback is occurring from or the speed at which it is occurring. This information can be important to allow the television monitor to generate its own on-screen displays to the user, e.g. time remaining. The information can also be used in association with a time-based content database to learn what is happening on screen or in the audio. Knowing what is happening on screen or in the audio can allow the monitor to provide additional contextual information to viewer.

It would be useful to provide an apparatus and a method that allows a receiving device to identify a playback position within an audiovisual content stream.

### SUMMARY

Apparatus for identifying an audiovisual content stream received from an audiovisual content source includes an audiovisual content display that displays the audiovisual content stream to a user. A closed captioning receiver receives a first plurality of consecutive closed captions from the audiovisual content stream substantially at a playback position. A comparator identifies the audiovisual content stream by matching the first plurality of closed captions to a database having a second plurality of closed captions. The database includes an identification of audiovisual content for each of the second plurality of closed captions. A presentation unit presents additional information related to the identification of the audiovisual content to the user. The database may include a playback location in the audiovisual content for each of the second plurality of closed captions, the comparator may estimate the playback position, and additional information related to the estimated playback position may be presented to the user.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a device that embodies the invention.

FIG. 2 is a block diagram of the device of FIG. 1 showing further details of the device.

FIG. 3 is a visual display that may be produced by the device of FIG. 1.

FIG. 4 is another visual display that may be produced by the device of FIG. 1.

FIG. 5 is a block diagram of another device that embodies the invention.

FIG. 6A is a diagram of a database structure that may be used with the invention.

FIG. 6B is a diagram of a portion of the database structure illustrating another aspect of its use.

FIG. 7 is a flowchart of a method that embodies the invention.

FIG. 8 is a flowchart of another method that embodies the invention.

### DETAILED DESCRIPTION

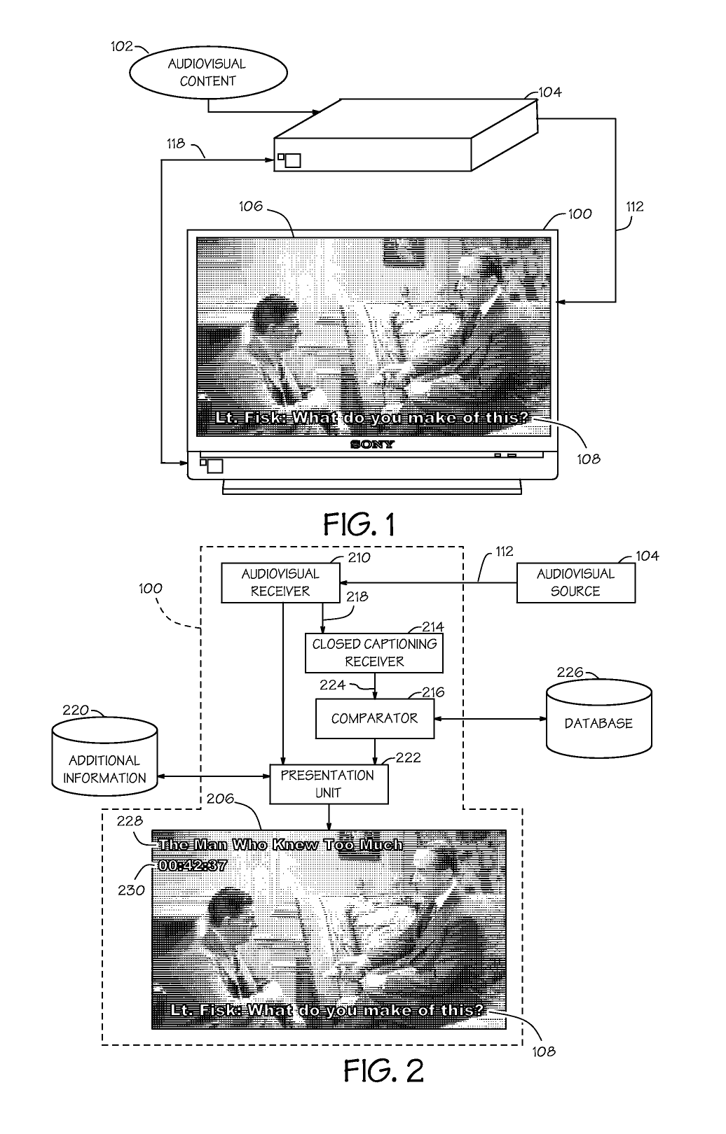

FIG. 1 shows a system that includes an audiovisual content display apparatus 100, a television in this example, that embodies the invention. An audiovisual content source 104 receives audiovisual content 102 that includes closed captioning or subtitle information 108 and provides it to the audiovisual content display apparatus 100 as an audiovisual content stream. The audiovisual content display apparatus 100 displays the audiovisual content stream to a user with or without displaying the closed captioning information 108, which is shown in the figure merely to make the nature of the closed captioning information visually apparent. For example, the audiovisual content display apparatus 100 may display the audiovisual content stream on a screen 106. The audiovisual content display apparatus 100 may also present an audio accompaniment that may be included with the audiovisual content 102.

The audiovisual content source 104 may be any of a variety of devices such as, but not limited to, a cable set-top box, a satellite receiver, an Internet Protocol Television (IPTV) receiver, a digital versatile disk (DVD) player, a Blu-ray Disc player, an HD DVD player, or a digital video recorder that are separate from the audiovisual content display apparatus 100. The audiovisual content 102 may be provided in a variety of forms such as broadcast television programming, DVD discs, or a hard disk recording. A remote control 108 allows the user to control the operation of the audiovisual content source 104 device.

For the purposes of this description the term “closed captioning” means a transcript or dialog of the audio portion of the audiovisual content that accompanies the audiovisual content as encoded characters rather than graphic representations of the characters of the caption. Closed captioning may be provided in accordance with a standard such as, but not limited to, the Electronic Industries Alliance (EIA) EIA-608 (line 21 captions) standard for closed captioning for NTSC TV broadcasts in the United States and Canada, EIA-708 captions for ATSC broadcasts, or teletext in PAL and SECAM broadcasts. The particular encoding of the closed captioning is not important for the purposes of the present invention, only that the closed captioning provides a stream of digitally encoded caption characters that are uniquely related to the audiovisual content that they accompany.

FIG. 2 shows a block diagram of the audiovisual content display apparatus 100. An audiovisual content receiver 210 receives the audiovisual content stream 112 from the audiovisual content source 104. The audiovisual content display 206 displays the audiovisual content stream 112 to the user.

A closed captioning (CC) receiver 214 receives consecutive closed captions 218 from the audiovisual content stream. Closed captions is used to mean groups of characters that make up a unit of closed captioning information such as the characters that would be displayed on a single line. For example, in the figure, the encoded character representation of “Lt. Fisk: What do you make of this?” is the closed caption associated with the portion of the audiovisual content stream being presented to the user. Consecutive closed captions is used to mean the closed captions in the sequence in which they appear in the audiovisual content stream. The closed captions are synchronized with the remaining content of the audiovisual content stream so that each closed caption is received by the closed captioning receiver 214 at a time that is substantially related to the playback position of the audiovisual content. It will be appreciated that the closed captions appear at intervals that are several seconds apart. Thus the receipt of a closed caption can resolve the playback position only to being within the time frame during which the closed caption would be displayed.

A comparator 216 receives the closed captions 224 from the closed captioning receiver 214. The comparator 216 identifies the audiovisual content stream 112 by matching the first plurality of closed captions to a database 226 having a second plurality of closed captions. The comparator 216 may match successive closed captions to the database 226 until a unique match is found. The database 226 includes an identification, such as the title, of the audiovisual content associated with each of the second plurality of closed captions. If a unique match is found for some number of consecutive closed captions, then the identification included with matching closed captions in the database 226 identifies the audiovisual content being received.

The database 226 may further include a playback location in the audiovisual content for each of the second plurality of closed captions. The comparator 216 may further estimate the playback position in the audiovisual content stream 112 based on the playback location information included with matching closed captions in the database 226.

The presentation unit 222 receives the identification of the audiovisual content stream 212 from the comparator 216 and presents additional information related to the identification of the audiovisual content to the user. The additional information may the identification or title 228 of the audiovisual content or enhanced information based on the identification. If the comparator estimates the playback position, the presentation unit 222 may present additional information related to the playback position. The additional information may the playback position or time 230 in the audiovisual content or enhanced information based on the playback position. For example, the identification of the audiovisual content may be used to obtain the total playing time and this may be combined with the playback position to present the remaining playing time for the content.

The presentation unit 222 may use the identity of the audiovisual content stream 212 along with the estimated playback position from the playback position identifier 216 to select or obtain additional information 220 for presentation to the user. The additional information 220 may be obtained from a variety of sources such as, but not limited to, a local data store or a network accessible source of additional information. The additional information 220 may be provided to the apparatus by any of a variety of means such as interleaved with the audiovisual content or by a separate network connection to a data provider which may be continuously or intermittently connected. The network connection may be shared with the connection that delivers the audiovisual content or may be an independent network connection such as an internet connection.

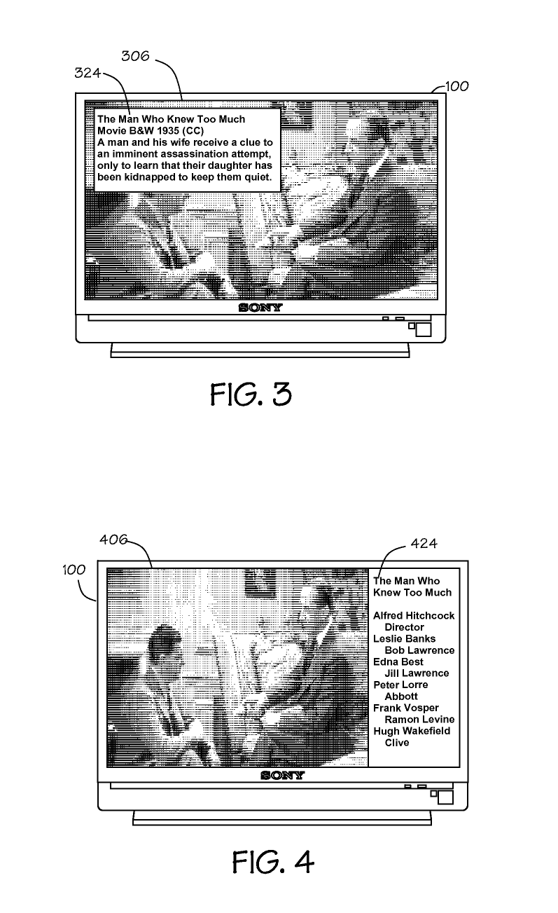

The presentation unit 222 may receive the output of the audiovisual content receiver 210 and mix the additional information 220 with the output. The additional information may be presented to the user on the audiovisual content display 206 in any of a variety of formats such as, but not limited to, an audiovisual content overlay 224 as shown in FIG. 2, a picture-in-picture (PIP) display 324 as shown in FIG. 3, or a picture outside picture (POP) display 424 as shown in FIG. 4.

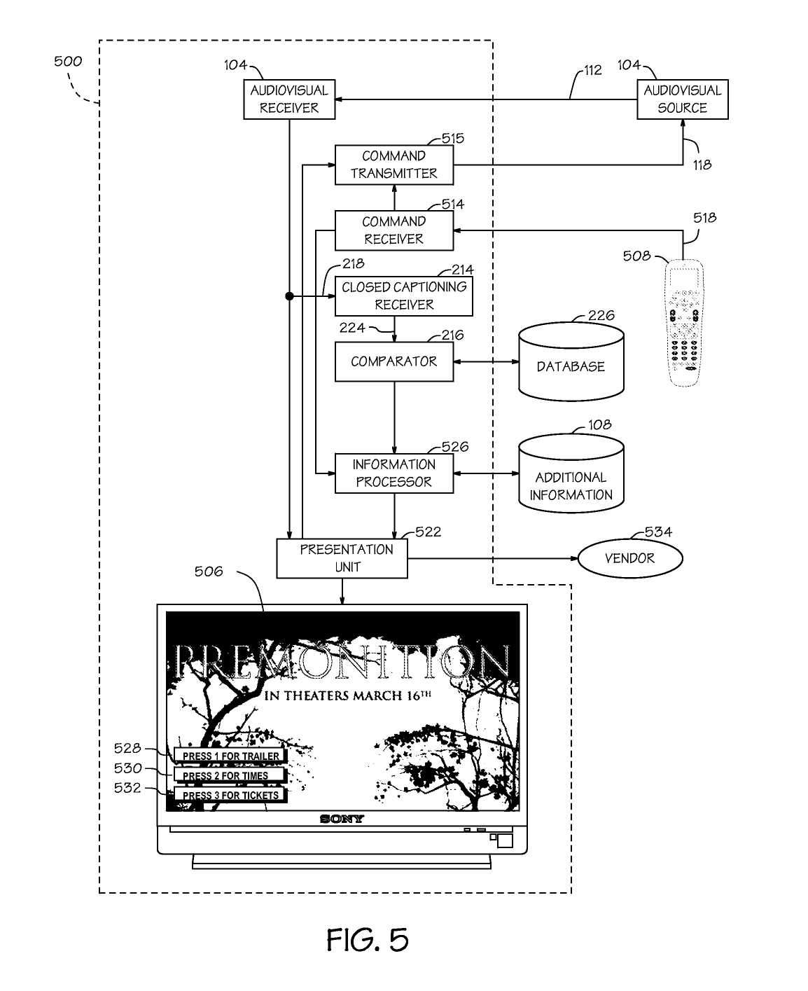

FIG. 5 shows a system that includes another audiovisual content display apparatus 500 that embodies the invention. An information processor 526 may receive identification and estimates of the playback position from the comparator 216. The information processor 526 may obtain additional information 508 related to the audiovisual contents and provide it to the presentation unit 522 to be displayed to the user.

The information provided to the presentation unit 522 by the information processor 526 may include interactive features such as menu items 528, 530, 532. The information processor 526 may receive remote control commands 518 from a command receiver 514 to accept user input. The command receiver 514 may recognize remote control commands that are intended for the information processor 526 rather than the audiovisual content source 104 and route them accordingly. The user input may, for example, allow a selection of a menu item 528, 530, 532. The information processor 526 may obtain further additional information 508 based on the user input and provide it to the presentation unit 522 to be displayed to the user.

The additional information 508 may include ordering information and a link to a vendor 534. The link may be an address on a network, such as a universal resource locator (URL) for the internet. The information processor 526 may present the ordering information to the user using the presentation unit 522, receive an order from the user using the command receiver 514, and transmit the order to the vendor using the link.

For example, the information processor 526 may determine that the audiovisual content is a commercial message for a movie. The additional information 508 for that commercial message may indicate that a trailer, local show times, and ticket ordering are available for the advertised movie. The information processor 526 may cause menu items 528, 530, 532 for those pieces of additional information to be presented to the user as links to the additional information. Using the received remote control commands, the information processor 526 may provide navigation to a link and receive a selection of the link from the user. The information processor 526 may then present additional information to the user in response to the selection of the link, such displaying the trailer, displaying local show times, or presenting an interactive ticket ordering screen. The information processor 526 may use other information such as geographic location of the audiovisual content display apparatus 500 or the user's payment information when processing these types of additional information.

The additional information presented to the user may be saved for later viewing. The additional information may be saved in the form of short descriptive phrases or links that allow the complete additional information to be retrieved for presentation by selection of the link, which may be presented in a list of links. The user may be presented with an offer to save a link, which is saved if the user so chooses. Offering to save a link may be done as an alternative to pausing the display of the audiovisual content or when the audiovisual content cannot be paused. Saved links may be kept until deleted or they may be deleted automatically after being viewed or after some time has elapsed since they were saved.

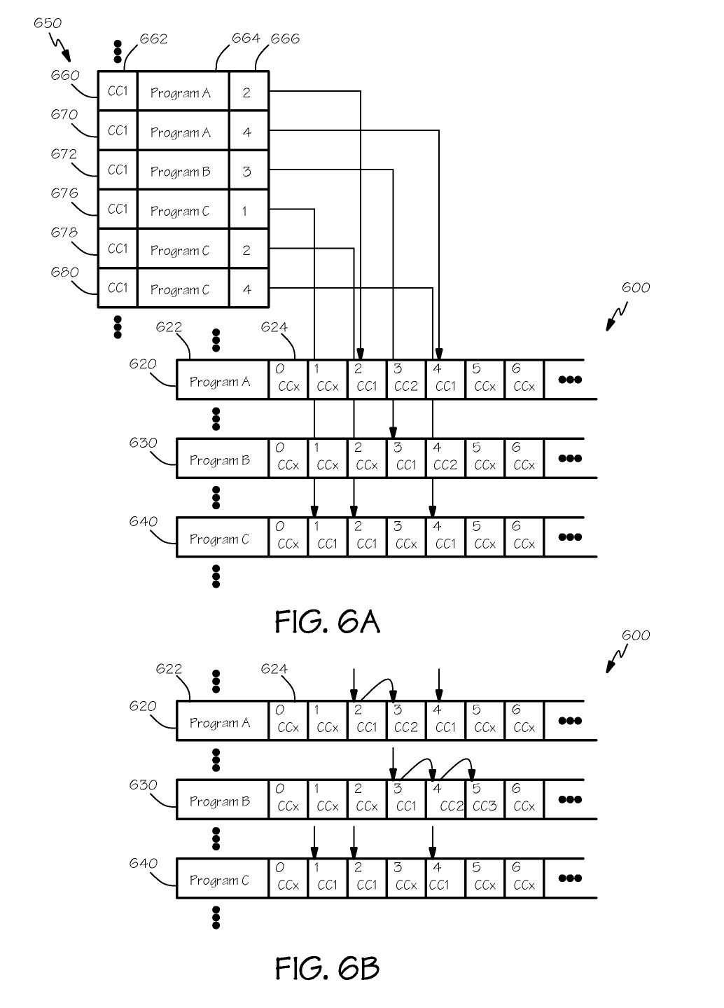

FIG. 6A illustrates a database structure that may be used to identify an audiovisual program from a sequence of consecutive closed captions from the audiovisual content stream. Three closed captions, identified as CC1, CC2, and CC3, are used for the purposes of illustrating the use of the database. For example, the three closed captions might be:
CC1: “Get the phone.”
CC2: “Hello.”
CC3: “It's for you Brant.”
   CCx identifies closed captions in the database other than CC1, CC2, and CC3. CCx captions may be different from one another.

The database structure may provide a table 600 of audiovisual program entries 620, 630, 640. Each audiovisual program entry 620 may include audiovisual program identification data and playback position 622 and a sequence of closed captions 624 for the identified audiovisual content. The database structure may further provide an index 650 of closed captions to identify audiovisual content containing a given closed caption. An entry 660 in the index 650 may include a closed caption 662, an audiovisual program pointer 664, and a caption offset 666. The entries in the index may be sorted by the closed captions 662.

The comparator 130 may include a first search engine that uses the index 650 to identify a first plurality of closed captions from audiovisual programs in the database 600 based on the first closed caption. As illustrated by FIG. 6A, if the first closed caption in a sequence of consecutive closed captions is CC1, the index 650 provides pointers to six closed captions in three audiovisual programs:
Program A, caption 2
Program A, caption 6
Program B, caption 3
Program C, caption 1
Program C, caption 2
Program C, caption 6

The comparator may further include a second search engine to compare a second closed caption for a consecutively following closed caption for each of the identified plurality of audiovisual program content from the database. As shown in FIG. 6B, if the second closed caption is CC2, the second search engine identifies Program A, caption 3 and Program B, caption 3 as matches from the group identified by the first search engine. The sequence of closed captions 624 for each audiovisual program entry 620 may be ordered consecutively to facilitate retrieval of the second closed caption for comparison.

The comparator may use the second search engine to compare successive closed captions for each of the plurality of audiovisual program content from the database identified by the preceding closed caption. Successive closed captions may be compared until a unique audiovisual program is identified and/or until all provided closed captions have been compared. In one embodiment, closed caption comparison continues even after a unique audiovisual program is identified to confirm the identification. If comparison of the provided closed captions does not identify a unique audiovisual program, an indication that no audiovisual program was uniquely identified by the comparator may be provided.

As shown in FIG. 6B, if the third closed caption for the third scene is CC3, the third search engine identifies Program B, caption 6 as a unique match from the group identified by the second search engine. Program B would be identified based on the consecutive closed caption sequence of CC1, CC2, and CC3. The program identification may be displayed to a user, stored in a location for use by other devices, transmitted to a device for use, or otherwise put into a tangible form for use.

If data is included in the database 600 that indicates the temporal position of each closed caption 624 in the identified program 622, then the matching of the sequence of closed captions may substantially identify the playback position in the audiovisual program. In some embodiments, the identity of the audiovisual program may be known and provided with the plurality of closed captions so that the comparator only compares the provided closed captions to the entry for the identified audiovisual program. For example, the audiovisual program may have been previously identified and the closed captions may be provided only to obtain an updated playback position.

A received audiovisual program may be temporally compressed or expanded. For example, an audiovisual program may be received at an increased rate to compress the program into an available length of time. The comparator may determine a ratio between the elapsed time between consecutive received closed captions and the computed time between those captions based on the temporal position information in the database to accommodate temporally modified programs. The comparator may further operate such that it will adjust the reported playback position based on the determined ratio.

It is possible that the sequence of consecutive closed captions may fail to match any sequence of closed captions 624 in the database 600. The failure to match may be the result of trying to identify an audiovisual program that is not in the database, trying to identify an audiovisual program that has been interrupted, such as by the insertion of a commercial message, or the result of some error in the transmission of the audiovisual program. A matching failure may initiate an attempt to retry identification of the audiovisual program based on subsequent closed captions.

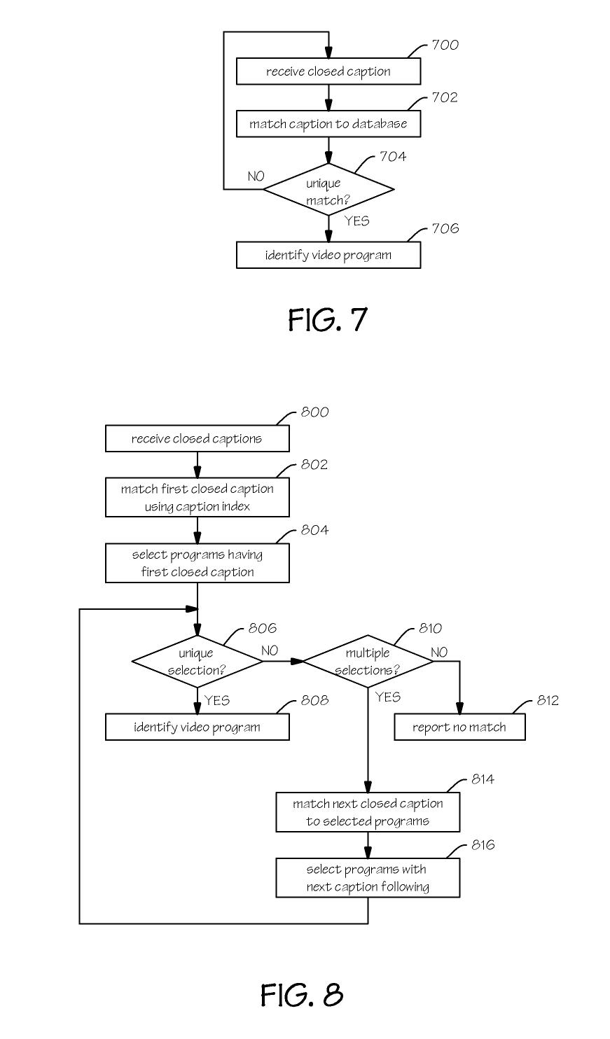

FIG. 7 is a flowchart for a method of identifying an audiovisual program that embodies the invention. A closed caption from the audiovisual program is received 200. The received closed caption is matched to a database of audiovisual programs that includes closed captions for each audiovisual program in the database 702. If there is a unique match between the received closed caption and a closed caption in the database for an audiovisual program 704-Yes, that audiovisual program is identified by the received closed caption 706. If the received closed caption matching does not uniquely match an audiovisual program 704-No, a following closed caption is received 702 and the method is repeated until comparing the consecutive closed captions to the database of audiovisual programs 704 uniquely identifies the video program 706.

In some embodiments, a single device, such as a television monitor or a video recorder, performs the entire method. In other embodiments, two devices may work cooperatively to perform the method. The first device may detect the closed captions and provide them to the second device for identification. The first device may be a device that receives video content such as a television monitor or a video recorder. The second device may be remote from the first device and may be coupled to the first apparatus by a network connection. The network connection may be shared with the connection that delivers the video content or may be an independent network connection such as an internet connection.

FIG. 8 is a flowchart for another method of identifying a video program that embodies the invention. A plurality of consecutive closed captions in the video program are received 800. A first closed caption is matched to the database of video programs using a first index that is sorted by closed captions 802 to select a first plurality of video programs in the database 804.

If the matching results in a unique selection of a single audiovisual program 806-YES, the identification of that audiovisual program is reported 808. If the matching results in a selection of multiple audiovisual program 810-YES, the next consecutive closed caption is matched to the selected audiovisual programs 814 and the audiovisual programs that have the next consecutive closed caption following the previous closed caption are selected 816. The test of the resulting selection of audiovisual programs continues with the test for a unique selection 806. If no audiovisual program is selected by a closed caption 810-NO, the failure to identify an audiovisual program may be reported 812.

The database entry for each audiovisual program entry may include the temporal position of each closed caption in the identified audiovisual program. Matching of a closed caption may substantially identify the temporal position in the audiovisual content. Information related to the temporal position of the closed captions in the identified audiovisual content may be provided. In some embodiments, the identity of the audiovisual content may be known and provided with the plurality of scene lengths to determine the temporal position within the given audiovisual content. For example, the audiovisual content may have been previously identified and the scene lengths may be provided only to obtain an updated temporal position.

The invention described herein may be embodied in specific hardware components that contain hardwired logic for performing the operations. Alternatively, program instructions may be used to cause a functional change in a general-purpose or special-purpose processing system that is programmed with the instructions, or any combination of programmed computer components and custom hardware components, to perform functions that embody the invention.

The invention described herein may be embodied in an article of manufacture that provides information in a form readable by a computer. The term “computer” as used in this description is intended to include any device or machine whose function can be altered by the receipt of information. Computers include, but are not limited to, central processing units, processors, controllers, and programmable arrays. When read by a computer, the information provided by the article of manufacture causes a functional change in the computer such that the computer performs functions and produces tangible results as determined by the information. The article of manufacture or the information it provides may be referred to as software, firmware, program, procedure, process, application, logic, and so on. Software, or any equivalent term, may be said to perform a function or produce a result meaning that when a computer reads the information that represents the software, the functional change in the computer causes the computer to perform a function or produce a result.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An audiovisual content display apparatus comprising:
an audiovisual content receiver that receives an audiovisual content stream from an audiovisual content source;
an audiovisual content display that displays the audiovisual content stream to a user;
a closed captioning receiver that receives a first plurality of consecutive closed captions from the audiovisual content stream substantially at a playback position;
a comparator that identifies the audiovisual content stream by matching the first plurality of closed captions to a database having a second plurality of closed captions, the database including an identification of an audiovisual content for each of the second plurality of closed captions; and
a presentation unit that presents additional information related to the identification of the audiovisual content to the user.

2. The audiovisual content display apparatus of claim 1, wherein the database further includes a playback location in the audiovisual content for each of the second plurality of closed captions, the comparator further estimates the playback position in the audiovisual content stream by matching the first plurality of closed captions to the database, and the presentation unit further presents additional information related to the estimated playback position.

3. The audiovisual content display apparatus of claim 1, further comprising an information processor that obtains the additional information related to the playback position within the audiovisual contents and provides it to the presentation unit.

4. The audiovisual content display apparatus of claim 3, wherein the information processor further:
obtains a link to the additional information;
causes the link for the additional information to be presented to the user;
provides navigation to the link responsive to inputs received from the user;
receives a selection of the link from the user; and
presents the additional information to the user in response to the selection of the link.

5. The audiovisual content display apparatus of claim 3, wherein the additional information includes ordering information and a link to a vendor, the information processor further:
presents the ordering information to the user;
receives an order from the user; and
transmits the order to the vendor using the link.

6. The audiovisual content display apparatus of claim 1, wherein the additional information is presented to the user on the audiovisual content display as one of a picture-in-picture (PIP) display, a picture outside picture (POP) display, and an audiovisual content overlay.

7. The audiovisual content display apparatus of claim 1, wherein the additional information is stored for presentation to the user at a later time.

8. The audiovisual content display apparatus of claim 1, wherein the comparator further comprises:
a first search engine to compare a first closed caption from the first plurality of closed captions to the database using a first index that is sorted by closed captions to select a first plurality of audiovisual content in the database; and
a second search engine to compare a consecutively following second closed caption from the first plurality of closed captions for each of the identified plurality of audiovisual content from the database to select a second plurality of audiovisual content from the previously selected plurality of content until a single audiovisual content is uniquely selected.

9. The audiovisual content display apparatus of claim 8, wherein the output port further provides an indication if no audiovisual content is uniquely identified by the plurality of scene lengths.

10. A method for identifying audiovisual video content, the method comprising:
receiving a first plurality of consecutive closed captions from the audiovisual content substantially at a playback position;
determining the identification of the audiovisual content by matching the first plurality of closed captions to a database having a second plurality of closed captions, the database including an identification of an audiovisual content for each of the second plurality of closed captions in the database; and
providing the identification of the audiovisual content.

11. The method for identifying audiovisual video content of claim 10, wherein the database further includes a playback location in the audiovisual content for each of the second plurality of closed captions in the database and the method further comprises estimating the playback position in the audiovisual content stream by matching the first plurality of closed captions to the database having a second plurality of closed captions, and providing the estimated playback position in the audiovisual content.

12. The method for identifying audiovisual video content of claim 10, further comprising:
obtaining a link to additional information related to the identification of the audiovisual content;
causing the link for the additional information to be presented to the user;
providing navigation to the link responsive to inputs received from the user;
receiving a selection of the link from the user; and
presenting the additional information to the user in response to the selection of the link.

13. The method for identifying audiovisual video content of claim 12, wherein the additional information includes ordering information and a link to a vendor, the method further comprising:
presenting the ordering information to the user;
receiving an order from the user; and
transmitting the order to the vendor using the link.

14. The method for identifying audiovisual video content of claim 10, wherein the additional information is presented to the user on the audiovisual content display as one of a picture-in-picture (PIP) display, a picture outside picture (POP) display, and an audiovisual content overlay.

15. The method for identifying audiovisual video content of claim 10, wherein the additional information is stored for presentation to the user at a later time.

16. The method for identifying audiovisual video content of claim 10, wherein the comparator further comprises:
a first search engine to compare a first closed caption from the first plurality of closed captions to the database using a first index that is sorted by closed captions to select a first plurality of audiovisual content in the database; and
a second search engine to compare a second closed caption from the first plurality of closed captions for a consecutively following closed caption for each of the identified plurality of audiovisual content from the database to select a second plurality of audiovisual content from the previously selected plurality of content until a single audiovisual content is uniquely selected.

17. The method for identifying audiovisual video content of claim 16, wherein the output port further provides an indication if no audiovisual content is uniquely identified by the plurality of scene lengths.

18. A method for identifying audiovisual content, the method comprising:
detecting a first plurality of consecutive closed captions in the audiovisual content;
providing the first plurality of closed captions to a comparator that compares the first plurality of closed captions to a database having a second plurality of closed captions, the database including an identification of an audiovisual content and a playback position in the audiovisual content for each of the second plurality of closed captions in the database; and
receiving an identification of the audiovisual content from the comparator.

19. The method for identifying audiovisual video content of claim 18, wherein the database further includes a playback location in the audiovisual content for each of the second plurality of closed captions in the database and the method further comprises estimating the playback position in the audiovisual content stream by matching the first plurality of closed captions to the database having a second plurality of closed captions, and providing the estimated playback position in the audiovisual content.

20. The method for identifying audiovisual video content of claim 18, further comprising:
obtaining a link to additional information related to the identification of the audiovisual content;
causing the link for the additional information to be presented to the user;
providing navigation to the link responsive to inputs received from the user;
receiving a selection of the link from the user; and
presenting the additional information to the user in response to the selection of the link.

21. The method for identifying audiovisual video content of claim 20, wherein the additional information includes ordering information and a link to a vendor, the method further comprising:
presenting the ordering information to the user;
receiving an order from the user; and
transmitting the order to the vendor using the link.

22. The method for identifying audiovisual video content of claim 18, wherein the additional information is presented to the user on the audiovisual content display as one of a picture-in-picture (PIP) display, a picture outside picture (POP) display, and an audiovisual content overlay.

23. The method for identifying audiovisual video content of claim 18, wherein the additional information is stored for presentation to the user at a later time.

24. The method for identifying audiovisual video content of claim 18, wherein the comparator further comprises:
a first search engine to compare a first closed caption from the first plurality of closed captions to the database using a first index that is sorted by closed captions to select a first plurality of audiovisual content in the database; and
a second search engine to compare a second closed caption from the first plurality of closed captions for a consecutively following closed caption for each of the identified plurality of audiovisual content from the database to select a second plurality of audiovisual content from the previously selected plurality of content until a single audiovisual content is uniquely selected.

25. The method for identifying audiovisual video content of claim 24, wherein the output port further provides an indication if no audiovisual content is uniquely identified by the plurality of scene lengths.
